(19) United States
(12) Patent Application Publication
(10) Pub. No.: US 2026/0065082 A1
(43) Pub. Date: Mar. 5, 2026

(54) HALLUCINATION DETECTION FOR LANGUAGE MODELS

(71) Applicant: Intuit, Inc., Mountain View, CA (US)

(72) Inventors: Jonathan Alexander RABIN, Kfar Sava (IL); Ido Meir MINTZ, Tel Aviv (IL); Guy SHTAR, Ness-Ziona (IL)

(21) Appl. No.: 18/819,814

(22) Filed: Aug. 29, 2024

(51) Int. Cl. G06N 5/02; G06F 18/23211; G06F 40/30; G06F 40/40

(52) U.S. Cl. CPC G06N 5/02; G06F 18/23211; G06F 40/30; G06F 40/40

(57) ABSTRACT

Certain embodiments of the disclosure provide techniques for hallucination detection. A method generally includes generating, via a first language model and based on a seed question, a plurality of semantically similar questions; processing the plurality of semantically similar questions with a second language model to generate a plurality of answers; processing the plurality of answers with a third language model to generate a plurality of factual statements; processing the plurality of factual statements with an embedding model to generate a plurality of embeddings; clustering the plurality of embeddings into a plurality of clusters; determining an average proximity score of the plurality of clusters based on a centroid of each of the plurality of clusters; and determining whether the plurality of answers generated by the second language model comprises a hallucination based on a number of the plurality of clusters and the average proximity score of the plurality of clusters.

### BACKGROUND

### Field

Aspects of the present disclosure relate to hallucination detection for language models.

### Description of Related Art

A key long-term goal of artificial intelligence (AI) is to create machines capable of understanding and engaging in conversation with humans using natural language. Dialogue systems, which can communicate with users in natural language, may carry out unstructured conversations, with users, on any topic (e.g., open-domain systems). Performant dialogue systems exhibit competence in understanding natural language, making informed decisions, and generating fluent, engaging, contextually appropriate, and accurate responses.

An example dialogue system may leverage language models, such as simple language model(s) and/or large language model(s) (LLM(s)), to perform natural language processing (NLP) tasks. A language model is a type of machine learning (ML) model that supports NLP tasks, such as generating text, analyzing sentiments, answering prompts (e.g., specific instructions and/or requests posed in natural language) in a conversational manner, translating text from one language to another, and/or the like. Language models make it possible for software to “understand” typical human speech or written content and respond to it by, in some cases, generating human-understandable responses through natural language generation (NLG). As used herein, the difference between a simple language model and an LLM is generally based on size of the model (often measured in terms of trainable parameters). For example, a language model with 1-2 billion parameters may be relatively small and referred to as a “simple language model,” while a language model with greater than 100 billion parameters may be larger and referred to as a large language model. However, it is noted, that the number of parameters generally associated with a simple language model and an LLM may change over time (e.g., a year from now, the scales may be different).

A popular LLM, which has gained much recent attention, is “ChatGPT,” produced by OpenAI® of San Francisco, California. Generative pre-trained transformer (GPT) models, such as ChatGPT, are a specific type of LLM based on a transformer architecture (e.g., architecture that uses an encoder-decoder structure and does not rely on recurrence and/or convolutions to generate an output), pre-trained in a generative and unsupervised manner (e.g., it learns from data without being given explicit instructions on what to learn). GPT models analyze prompts and predict the best possible responses based on their understanding of the language.

Language models, and more specifically LLMs such as ChatGPT, represent a transformative force in many industries by assimilating vast amounts of knowledge and strategically deploying it to improve outcomes, ranging from answering specific questions to automating significant parts of complex workflows. Further, with their ability to streamline communication, facilitate data analysis, support compliance, and/or contribute to business and/or financial planning, among others, language models enhance efficiency, accuracy, and decision-making in these industries. However, as with any new technology, there are also concerns around its limitations, ethical implications, and potential risks. For example, while a powerful tool, a language model may only be as good as the underlying training data used to train the model, and there may be cases where its responses are inaccurate. In particular, a language model may generate plausible-sounding but incorrect, or misleading, responses with a high level of certainty, so-called “hallucinations,” giving the impression of confidence despite being inaccurate. These hallucinations may occur due to various factors, such as limitations in training data, biases in the model, and/or the inherent complexity of language. For example, hallucinations may be fabricated, non-existent, and made up facts (e.g., not learned); however, the training data used to train a model that is producing the hallucinations may affect the amount and/or type of hallucinations that are produced by the model. Occurrences of hallucinations may be difficult for a user of the language model to identify, especially one that is not an expert in the particular field to which the language model's response is directed.

This presents a technical problem in industries where language models are utilized to provide answers, advice, recommendations, and/or help with the preparation of documents and/or reports. For example, a language model designed to aid in the preparation of an organization's financial reports for external reporting purposes may, in some cases, generate answers to specific financial questions about an organization that are exceedingly confident, yet erroneous. These answers may be used in the preparation of an organization's financial reports for external reporting purposes. Thus, without additional oversight, this incorrect information may be reported to external stakeholders, the government, credit institutions, and/or the like. The risks of such inaccurate financial reporting may include reputational damage, economic loss, penalties, fines, legal action, and/or even bankruptcy. Similar repercussions, when solely relying on language models, are also present in other high-risk industries, such as healthcare, engineering, science, etc. For example, incorrect answers and/or data generated by a language model and relied on by professionals in these industries may lead to serious injury, loss of life, loss of assets, destruction of property, legal liability, and/or the like. Accordingly, there is a need for a technical solution for detecting inaccurate and/or misleading responses output by language models, and specifically responses relied on to make critical decisions (e.g., financial decisions, health decisions, decisions related to construction, scientific decisions, political decisions, etc.).

### SUMMARY

Certain embodiments provide a method of hallucination detection for language models. The method generally includes generating, via a first language model and based on a seed question, a plurality of semantically similar questions; processing the plurality of semantically similar questions with a second language model to generate a plurality of answers; processing the plurality of answers with a third language model to generate a plurality of factual statements; processing the plurality of factual statements with an embedding model to generate a plurality of embeddings; clustering the plurality of embeddings into a plurality of clusters; determining an average proximity score of the plurality of clusters based on a centroid of each of the plurality of clusters; and determining whether the plurality of answers generated by the second language model comprise a hallucination based on a number of the plurality of clusters and the average proximity score of the plurality of clusters.

Other embodiments provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain embodiments and are therefore not to be considered limiting of the scope of this disclosure.

FIG. 1 depicts an example system implementing a hallucination detector.

FIG. 2 depicts an example workflow for detecting hallucination in natural text generated by a language model.

FIG. 3 depicts example hallucination detection for an example seed question according to the workflow of FIG. 2.

FIG. 4 depicts an example method of hallucination detection for language models.

FIG. 5 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Hallucinations in natural text generation, such as by language models, is a technically challenging problem, and the causes of such hallucinations are complex and multifaceted. For example, a large-scale data corpus employed for training language models (e.g., specifically LLMs) may inevitably contain some erroneous information, which gets learned and stored in the models' parameters. For example, the Internet, which provides a significant source of data for training language models, is replete with inaccurate information. Consequently, when generating text, language models may repeat the inaccurate information thereby resulting in the production of hallucinations. Further, the inadequate representation of topics, the presence of biases, and/or noise, such as inconsistencies or irrelevant information, may lead to the generation of factually incorrect and misleading responses, e.g., hallucinations, by language models. As another example, language models may have limitations in fully understanding the context and/or intent behind user prompts (e.g., specific instructions and/or requests posed in natural language). For instance, language models may struggle with interpreting the subtleties of human language, including irony, sarcasm, and/or cultural references. Language models may generate outdated or irrelevant information in situations where nuance is key to understanding the intent behind a prompt.

Various approaches exist for detecting hallucinations in language models' outputs, including human-based and statistical evaluations. First, human-based evaluations may include a human scoring text output by a language model or directly comparing it with some ground truth (e.g., what is expected of the model to ideally generate). Manually checking whether each model output comprises an incorrect and/or misleading response to a particular prompt (e.g., provided as input into the langue model) is cumbersome, time-consuming, and generally impractical where the language model is used to produce a large number of responses. In fact, for a large number of prompts provided as input to the language model, the technical problem is intractable when considering manual (e.g. human-based mental process) approaches. For example, when the language model is used to produce a sufficiently large number of responses, it could take a human a significant and unreasonable amount of time to check whether all of the responses are correct, clear, and relevant to the prompts used to trigger such responses by the language model. Where an application requires a low latency response, a human reviewer is an infeasible technical solution. Further, as described above, in some cases, it may be difficult for a human to identify hallucinations in model output due to a lack of knowledge the human may have on the subject matter related to the model output.

Second, statistical evaluation may involve performing vocabulary matching between the generated text and reference target text. In some cases, vocabulary matching may be performed by employing a metric known as recall-oriented understudy for gisting evaluation (ROGUE) (e.g., metrics that measure the similarity between generated text and reference text, that emphasizes recall over precision). In some cases, vocabulary matching may be performed by employing a metric known as bilingual evaluation understudy (BLEU) (e.g., metric that relies on similarities across the same words/phrases/etc., comparing the presence of unigrams (e.g., single words), bigrams (e.g., pairs of words), trigrams, and higher-order n-grams between a prompt and its response). Generated text refers to the model output text and target text refers to the ground truth text.

Some other statistical-based approaches may use log probability to gauge the likelihood of a generated text sequence including a hallucination by assessing how well it aligns with the model's understanding of the language patterns. When language models hallucinate, they often produce text that is significantly different from expected language patterns. However, log probability calculations may be used to identify these anomalies. For example, sequence log probability (Seq-Logprob) is one metric that may be used to measure how likely some generated text is based on the language model's understanding. Sequence log probability offers a way to measure the language model's confidence in its generated text.

Another example technique that has been conventionally used for question-level hallucination detection (e.g., detection of question(s) that are likely to generate a hallucination by a language model) involves perturbing semantically equivalent questions to evaluate the consistency of a language model's responses across variants of the same question. This technique examines the language model's answers to the perturbed questions to identify cases where the language model consistently provides incorrect responses to a specific question, which may be indicative of a question-level hallucination. For example, a verifier language model (e.g., a verifier LLM) may be prompted to determine the consistency of each answer generated by the language model with respect to each other answer generated by the language model. For instance, if 8 answers are generated, then the verifier language model may be prompted 28 times to determine the consistency of one generated answer with respect to another answer generated by the language model

$$( e . g . , \frac{n !}{[ ( n - r ) ! * r ! ]} = \frac{8 !}{[ ( 8 - 2 ) ! * 2 ! ]} = 28 ,$$

where r represents the number of answers per combination verified by the verification LLM for consistence and n represents the number of generated answers). While this technique may help to detect and address hallucinations of a language model, such as an LLM, this technique is extremely time-consuming, computationally expensive (based at least on prompting the verifier language model to determine the consistency between each generated answer and another generated answer to a similar question), and difficult to scale, especially as the number of generated answers that need to be checked increases.

Thus, hallucinations are a major challenge for developers working with language models, such as LLMs, adding a layer of unpredictability and complexity that may be particularly difficult and expensive to diagnose and fix.

Embodiments described herein overcome the aforementioned technical problems and improve upon the state of the art by introducing techniques that utilize clustering for detecting hallucinations in natural text generation, such as by language models. Clustering is an unsupervised machine learning technique that is used to group comparable data points, for example from a heterogeneous dataset, into a number of clusters. Clustering may involve steps for evaluating the similarity of the different data points based on a metric (e.g., such as a Euclidean distance, a cosine similarity, a Manhattan distance, etc.) and grouping the data points with the highest similarity score together. As described herein, clustering techniques may be specifically used to cluster multiple factual statements associated with answers generated by a language model based on prompting the language model with multiple semantically similar questions. The clusters may then be evaluated to determine whether the language model is hallucinating, or put differently, confidently generating incorrect and/or misleading answers to the semantically similar questions.

As used herein, a “factual statement” may refer to a declaration that asserts information. A factual statement may have the characteristic(s) of being quantifiable, observable, and/or empirical, meaning it may be proven or disproven, such as through examination or observation according to established facts or data. Further, as used herein, an “answer” may refer to a reply or response to a question, request, prompt, etc. In certain aspects, an answer may include features of a factual statement (e.g., a factual statement may include all or a portion of the answer). In certain aspects, an answer may include features of two or more factual statements (e.g., the answer may be broken down into two or more factual statements).

For example, the techniques described herein may be used to detect whether a language model is hallucinating on a particular question, referred to herein as a “seed question.” The hallucination detection techniques may include steps for generating semantically similar questions to the seed question and prompting the language model to generate an answer to each question. The answers may be transformed into a collection of factual statements, which may then be clustered into multiple clusters. For example, the factual statements may be converted into multiple embeddings (e.g., one embedding for each factual statement), using embedding techniques, models, and/or encoders (e.g., a trained neural network encoder model). As used herein, embedding is the process by which text is given numerical representation in a vector space. The hallucination detection techniques then compare each embedding against one or more other embeddings to determine a relatedness and/or similarity of each embedding to the other embeddings, and more specifically the relatedness and/or similarity of each factual statement to other factual statements associated with the embeddings, to create the clusters. Intra-cluster proximity (e.g., a measure of the distance between embeddings within a same cluster), inter-cluster proximity (e.g., a measure of the distance between centroids, e.g., mean or center points, of the clusters), and/or a number of clusters created may be considered to determine whether the answers (e.g., generated by the language model based on prompting the language model with the semantically similar questions) include a hallucination. A hallucination generated by the language model indicates that the language model may hallucinate when prompted with the seed question (and/or one of the semantically similar questions to the seed question).

The hallucination detection techniques described herein thus provide significant technical advantages over conventional solutions, such as computational efficiency. This technical effect overcomes technical problems of increased resource consumption, scalability, and limited processing capabilities in conventional approaches. For example, the hallucination detection techniques, described herein for language models, need not prompt a language model multiple times to evaluate the consistency of a language model's responses across variants of the same question, like conventional approaches (which are too slow and expensive to run at scale). Instead, the hallucination detection techniques leverage the fact that hallucinations have a wide range of variance in answers and based on this fact, measure the distance (e.g., semantic distance) between embeddings of various answers to evaluate their similarity, which provides a technical advantage over those conventional approaches.

Notably, the improved hallucination detection techniques described herein can further improve the function of any existing application that utilizes language models, such as for question answering. In some cases, a language model used to answer a particular question may be evaluated to determine whether the language model is hallucinating on the question. In this way, if the language model is determined to be hallucinating, the language model may refrain from displaying any incorrect and/or misleading answer to a user (e.g., in response to the question) or may display the answer with a disclaimer that the answer may include incorrect and/or misleading information, which may help to avoid any problems that would have otherwise been created by only displaying the answer (e.g., without the disclaimer). Thus, a further beneficial technical effect of the techniques described herein includes beneficially helping to avoid a wide range of significant harms, such as economic loss, serious injury, legal liability, destruction of property, etc. Further, if the language model is determined to be hallucinating, in some cases, the language model may be fine-tuned to avoid subsequent hallucinations by the language model at least with respect to a subject matter of the particular question.

### Example System Implementing a Hallucination Detector

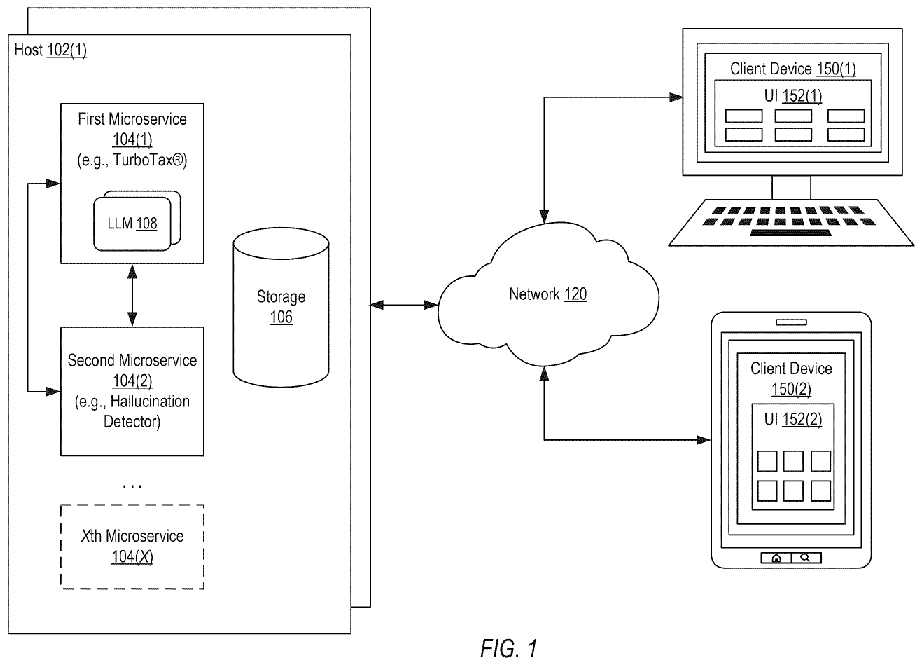

FIG. 1 depicts an example system 100 implementing a hallucination detector, such as a software-defined service (e.g., in some cases, a cloud-native software-defined service), also referred to herein as “a microservice 104.” Generally, microservices 104 are loosely coupled and independently deployable services (or software) that provide functionality to a wide variety of applications. Microservices 104 may enable segmented, granular level functionalities within a larger system infrastructure.

As shown in FIG. 1, system 100 comprises client devices 150(1)-(2) (collectively referred to herein as “client devices 150”) and host(s) 102 interconnected through a network 120. Network 120 may be, for example, a direct link, a local area network (LAN), a wide area network (WAN), such as the Internet, another type of network, or a combination of one or more of these networks.

Host(s) 102 may be geographically co-located servers on the same rack or on different racks in any arbitrary location in a data center. Host(s) 102 may be constructed on a server grade hardware platform and include components of a computing device such as, one or more processors (central processing units (CPUs)), one or more memories (random access memory (RAM)), one or more network interfaces (e.g., physical network interfaces (PNICs)), storage 106, and other components (e.g., only storage 106 is shown in FIG. 1).

A first host 102(1) in system 100 may host a plurality of microservices 104(1)-(X) (collectively referred to herein as “microservices 104”), where X is an integer greater than one. The microservices 104 may be deployed using virtual machines (VMs) and/or container(s) running on first host 102(1) (e.g., where first host 102(1) is running a hypervisor (not shown) used to abstract processor, memory, storage, and networking resources of first host 102(1)'s hardware platform).

Client device 150(1) and client device 150(2) may each include a user interface (UI) 152(1), 152(2), respectively, which may be used to communicate with, at least, a first microservice 104(1), a second microservice 104(2), and/or through an X-th microservice 104(X) using the network 120. For example, communication between client devices 150 and a microservice 104 may be facilitated by one or more application programming interfaces (APIs). Examples of client devices 150 may include a smartphone, a personal computer, a tablet, a laptop computer, and/or other devices.

As shown in FIG. 1, in certain embodiments, the first microservice 104(1) implements an information service, which is any network 120 accessible service that maintains financial data, medical data, personal identification data, and/or other data types. For example, the information service may include TurboTax® and its variants made commercially available by Intuit® of Mountain View, California. In certain embodiments, the first microservice 104(1) implements one or more language models 108, such as LLM(s). First microservice 104(1) may implement language model(s) 108 to provide responses to user prompts, including responses such as answers, advice, and/or help with the preparation of documents and/or reports. For example, TurboTax®, an example information service, may utilize a language model 108 to aid users of the application with preparing one or more financial documents. Language model 108 may provide answers to questions asked by a user of the application, prepare and output one or more reports and/or documents for the user, etc.

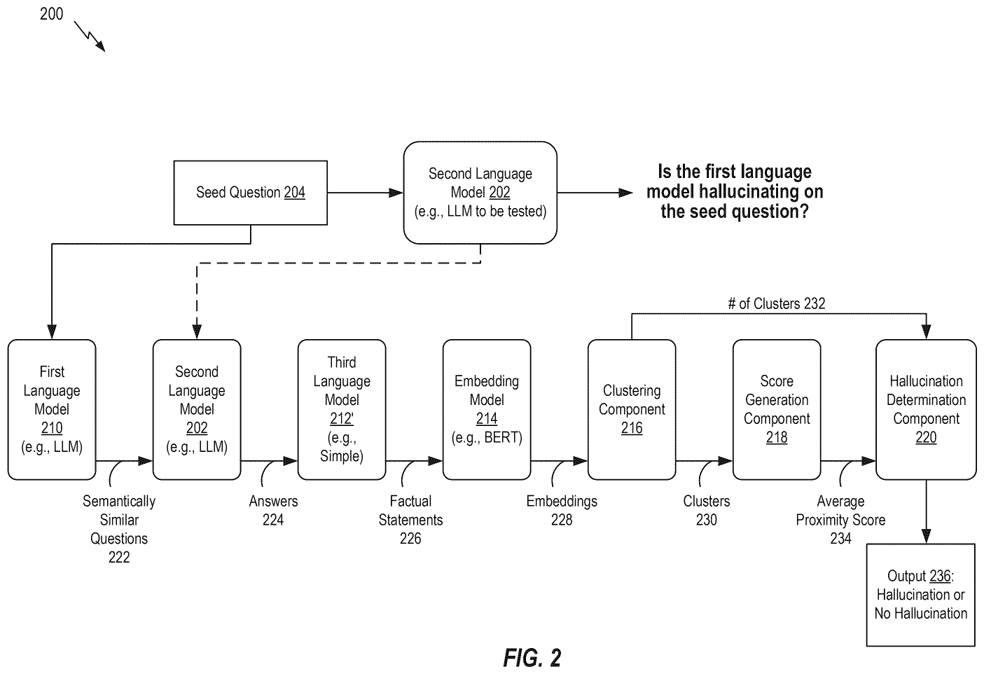

In certain embodiments, the second microservice 104(2) implements a hallucination detector service. The hallucination detector service (“hallucination detector”) may be a service used to perform hallucination detection in natural text generation. For example, in certain embodiments, the hallucination detector may be configured to detect hallucinations generated by language model 108. In certain embodiments, the hallucination detector may be configured to determine whether language model 108 is hallucinating in response to a particular question (e.g., a seed question). In certain embodiments, the hallucination detector may provide and/or make available, to first microservice 104(1) (e.g., the information service) the determination that the language model 108 is hallucinating or not, such that one or more actions may be taken to mitigate the hallucination or help prevent the dissemination of hallucinated content to an end user of first microservice 104(1) and/or downstream applications. Although not shown in FIG. 1, in certain embodiments, the hallucination detector implements one or more language models, such as simple language model(s) and/or LLM(s), to perform the hallucination detection. Use of the language model(s) to perform the hallucination detection is depicted and described below with respect to FIG. 2.

Though FIG. 1 depicts each of first host 102(1), storage 106, client device 150(1), and client device 150(2) as single devices for ease of illustration, first host 102(1), storage 106, client device 150(1), and/or client device 150(2) may be embodied in different forms for different implementations. Further, though FIG. 1 depicts only two hosts 102 and two client devices 150, other embodiments may include more or less hosts 102 and/or client devices 150, and client devices 150 may use any combination of microservices 104 on any host 102 where microservices 104 are deployed.

### Example Workflow for Hallucination Detection for an LLM

FIG. 2 depicts an example workflow 200 for detecting hallucination in natural text generated by a second language model 202. In certain embodiments, second language model 202 may be an example of language model 108 of FIG. 1. In certain embodiments, second language model 202 may be an LLM.

Workflow 200 may be performed to determine whether second language model 202 is hallucinating in response to a seed question 204. Seed question 204 may be any question provided as input to second language model 202, thereby prompting second language model 202 to produce a response, also referred to herein as an answer, or more generally, a model output. If second language model 202 is determined to be hallucinating in response to seed question 204, then one or more actions may be taken to mitigate the hallucination, as described in detail below.

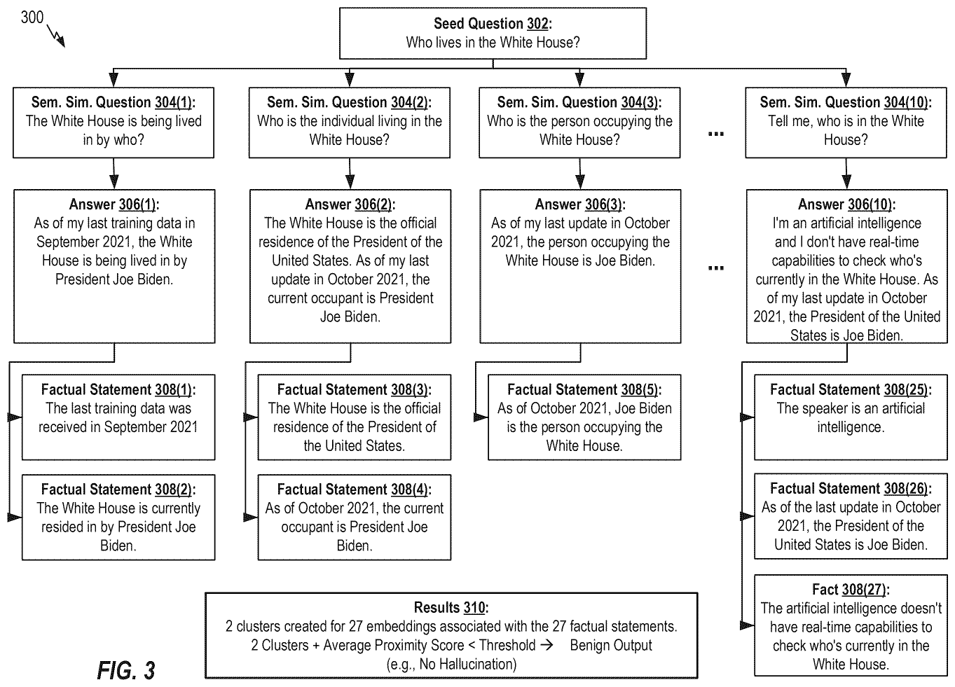

FIG. 3 depicts example hallucination detection for an example seed question 302 “Who lives in the White House?” based on workflow 200 depicted in FIG. 2. FIGS. 2 and 3 are described in conjunction below. It is noted that FIG. 3 describes only one example seed question 302 for which a language model may produce a response and thus workflow 200 may be used to determine whether the response includes a hallucination. As such, although not described herein, other seed questions may be considered for hallucination detection according to workflow 200 depicted in FIG. 2.

Workflow 200 begins with a first language model 210 generating semantically similar questions 222 to seed question 204. Semantic similarity is used to identify questions that convey similar meanings to each other, but are phrased differently. For example, the focus of generating semantically similar questions 222 is on the structure and lexical resemblance of the semantically similar questions 222 to seed question 204. First language model 210 may be another example of a language model, such as a language model implemented by the hallucination detector in FIG. 1. In certain embodiments, first language model 210 may be an LLM. An example first language model 210 includes GPT-4® made publicly available by OpenAI® of San Francisco, California.

For example, as shown in FIG. 3, based on prompting first language model 210 to generate semantically similar questions to seed question 302, first language model 210 may be triggered to output semantically similar questions 304(1)-304(10) (collectively referred to herein as “semantically similar questions 304”). Semantically similar question 304(1) includes a question “The White House is being lived in by who?”. Semantically similar question 304(2) includes a question “Who is the individual living in the White House?”. Semantically similar question 304(3) includes a question “Who is the person occupying the White House?”. Other semantically similar questions 304 may be generated up to semantically similar question 304(10), which includes a question “Tell me, who is in the White House?”. Although the example in FIG. 3 depicts the generation of only ten example semantically similar questions 304 to seed question 302, in some other examples, more or less semantically similar questions 304 may be generated (e.g., such as by first language model 210 in FIG. 2).

Returning to FIG. 2, workflow 200 then proceeds with second language model 202 processing the semantically similar questions 222 to generate a plurality of answers 224. For example, second language model 202 may be prompted to output an answer 224 for each semantically similar question 222 (e.g., one answer 224 per semantically similar question 222 may be generated). Second language model 202 may be the language model being tested, or put differently, the language model that workflow 200 is evaluating for the production of a hallucination with respect to seed question 204.

For example, as shown in FIG. 3, based on prompting second language model 202 to process semantically similar questions 222 and generate answers 224, second language model 202 may be triggered to output answers 306(1)-306(10) (collectively referred to herein as “answers 306”). Answer 306(1) represents an answer to semantically similar question 304(1) indicating “As of my last training data in September 2021, the White House is being lived in by President Joe Biden.” Answer 306(2) represents an answer to semantically similar question 304(2) indicating “The White House is the official residence of the President of the United States. As of my last update in October 2021, the current occupant is President Joe Biden.” Answer 306(3) represents an answer to semantically similar question 304(3) indicating “As of my last update in October 2021, the person occupying the White House is Joe Biden.” Other answers 306 may be generated up to answer 306(10), which includes an answer “I'm an artificial intelligence and I don't have real-time capabilities to check who's currently in the White House. As of my last update in October 2021, the President of the United States is Joe Biden,” to semantically similar question 304(10). Again, although the example in FIG. 3 depicts the generation of only ten example answers 306 to ten example semantically similar questions 304, in some other examples, more or less answers 306 may be generated (e.g., such as by second language model 202 in FIG. 2).

Returning to FIG. 2, workflow 200 then proceeds with a third language model 212 processing the answers 224 to generate a plurality of factual statements 226. For example, third language model 212 may be prompted to output one or more factual statements 226 for each answer 224 (e.g., a one-to-one relationship or a one-to-many relationship between an answer 224 and the factual statement(s) generated for the answer 224). Third language model 212 may be another example of a language model, such as a language model implemented by the hallucination detector in FIG. 1. In certain embodiments, third language model 212 may be an LLM. In certain embodiments, third language model 212 may be a simple language model (e.g., a smaller, faster, and/or cheaper language model than an LLM, such as Gemma 2 (e.g., having 2.6B parameters) made available by Google® or any other small, custom fine-tuned ML model). In certain embodiments, third language model 212 may be the same model as first language model 210. An example third language model 212 includes GPT-4®.

For example, as shown in FIG. 3, based on prompting third language model 212 to process answers 224 and generate factual statements 226, third language model 212 may be triggered to output factual statements 308(1)-308(27) (collectively referred to herein as “factual statements 308”). Factual statement 308(1) represents a first factual statement associated with answer 306(1) indicating “The last training data was received in September 2021.” Factual statement 308(2) represents a second factual statement associated with answer 306(1) indicating “The White House is currently resided in by President Joe Biden.” Factual statement 308(3) represents a first factual statement associated with answer 306(2) indicating “The White House is the official residence of the President of the United States.” Factual statement 308(4) represents a second factual statement associated with answer 306(2) indicating “As of October 2021, the current occupant is President Joe Biden.” Factual statement 308(5) represents a first factual statement associated with answer 306(3) indicating “As of October 2021, Joe Biden is the person occupying the White House” (only one factual statement 308 is generated for answer 306(3)).

Other factual statements 308 may be generated up to factual statements 308(25)-308(27), which represent factual statements 308 generated for answer 306(10). Specifically, factual statement 308(25) represents a first factual statement associated with answer 306(10) indicating “The speaker is an artificial intelligence.” Factual statement 308(26) represents a second factual statement associated with answer 306(10) indicating “The speaker is an artificial intelligence.” Factual statement 308(27) represents a third factual statement associated with answer 306(10) indicating “The artificial intelligence doesn't have real-time capabilities to check who's currently in the White House.” Although the example in FIG. 3 depicts the generation of only 27 example factual statements 308 for ten example answers 306, in some other examples, more or fewer factual statements 308 may be generated (e.g., such as by third language model 212 in FIG. 2).

Workflow 200 then proceeds with an embedding model 214 processing the factual statements 226 to generate a plurality of embeddings 228. Embedding in NLP is a technique where individual words and/or phrases are represented as real-valued vectors in a lower-dimensional space and used to capture inter-word and/or inter-phrase semantics. For example, each of the factual statements 226 may be converted to numerical representations, for example, vector embeddings, using embedding model 214 (although in some other examples, alternative embedding techniques and/or encoders may be used to generate embeddings 228. Here, each factual statement 226 is represented by a real-valued vector, referred to as an embedding 228, with two or more dimensions. The dimensionality of an embedding 228 refers to a number of elements that make up the embedding (e.g., the vector). For example, a three dimension embedding may be a vector such as {3, 1, 4}having three elements.

An example embedding model 214 used to generate embeddings 228 may include a bidirectional encoder representations from transformers (BERT).

Although not shown in FIG. 2, in certain embodiments, embeddings 228 are normalized. For example, the dimension of embeddings 228 may be normalized between zero and one to help avoid bias and the effects of magnitude of different vector elements. Further, normalization may be performed to improve empirical accuracy and/or theoretical justifications. Normalization of embeddings 228 may occur directly after embeddings 228 are generated and before clustering begins, as described below.

After generating, and in some cases normalizing, embeddings 228, workflow 200 proceeds with a clustering component 216 clustering the plurality of embeddings 228 into a plurality of clusters 230. For example, embeddings 228 are compared against one another and organized into two or more clusters 228 in a low-dimensional space. The comparison of the embeddings 228 may be used to determine a relatedness and/or similarity of each embedding 228 to another embedding 228, which makes up the plurality of embeddings 228. In certain embodiments, the comparison is performed by determining a distance metric between two embeddings 228. The distance metric may be calculated, for example, as a Euclidean distance, where a Euclidean distance is the length of a segment connecting (e.g., a straight line distance between) two points in either a plane or in a multi-dimensional space, as a cosine similarity metric, a Manhattan distance metric, and/or the like. A small distance metric calculated between two embeddings 228 may indicate that the embeddings are likely related, and thus these embeddings 228 may be assigned to a same cluster 230. Alternatively, a large distance metric calculated between two embeddings 228 may indicate that the embeddings are likely not related, and thus these vector embeddings may not be assigned to a same cluster 230.

Each cluster 230, created by clustering component 216, may be represented by its centroid. Cluster 230's centroid may represent the average point in space for the respective cluster 230.

In certain embodiments, clustering component 216 may perform clustering using a hierarchical density-based clustering algorithm, such as hierarchical density-based spatial clustering of applications with noise (HDBSCAN). HDBSCAN is a clustering algorithm that uncovers clusters 230 based on the density distribution of embeddings 228. Unlike some other clustering methods, HDBSCAN does not require specifying the number of clusters 230 in advance, making it more adaptable to different sets of embeddings 228, such as created via workflow 200. HDBSCAN may use high-density regions to identify clusters 230 and view isolated and/or low-density embeddings 228 as noise. As such, when using HDBSCAN in some cases, one or more embeddings 228 may not be assigned to any cluster 230. In certain aspects, embedding(s) 228 not assigned to a cluster may each form a single respective cluster on their own or be added to one large cluster with all other unclustered embeddings 228 (e.g., either option may help to increase the chances of detecting hallucinations). Embedding(s) 228 not assigned to a cluster 230 may indicate the tendency for hallucinations given all embeddings 228 associated with factual statements 226/answers 224 associated with semantically similar questions 222 are not similar, when they are expected to be similar. HDBSCAN may also be helpful to analyze embeddings 228 with varying densities, given HDBSCAN may create a hierarchical tree of clusters 230 that enable the analysis of the embeddings 228 and/or cluster 230 at different levels of granularity.

In certain other embodiments, clustering component 216 may perform clustering using an agglomerative clustering algorithm. Using this algorithm, each embedding 228 may first be treated as its own individual cluster. The algorithm may proceed by successively merging (or agglomerating) clusters using a selected linkage criterion. The output of this algorithm may include clusters 230 shown in FIG. 2.

In certain aspects, clustering may be performed using the HDBSCAN instead of the agglomerative clustering algorithm based on performing empirical experiments, which indicate that the HDBSCAN provides better accuracy for clustering than the agglomerative clustering algorithm. Alternatively, in certain aspects, clustering may be performed using the agglomerative clustering algorithm instead of the HDBSCAN based on performing empirical experiments, which indicate that the agglomerative clustering algorithm provides better accuracy for clustering than the HDBSCAN. In certain aspects, an agglomerative clustering algorithm may be used for clustering instead of the HDBSCAN based on the agglomerative clustering being simple to understand, deterministic, and/or less sensitive to parameter selection.

For example, in FIG. 3, 27 embeddings (not shown in FIG. 3) may be generated for factual statements 308(1)-(27). In some cases, a respective dimension of each of the 27 embeddings may be normalized between zero and one. Based on comparing each of the 27 embeddings against one another, the 27 embeddings may result in the creation of two clusters. A first subset (e.g., where a subset refers to “one or more”) of the 27 embeddings may be assigned to the first cluster and a second subset of the 27 embeddings may be assigned to the second cluster. The first subset of the 27 embeddings included in the first cluster may include embeddings that are more similar to each other than the embeddings included in the second cluster. Similarly, the second subset of the 27 embeddings included in the second cluster may include embeddings that are more similar to each other than the embeddings included in the first cluster.

Returning to FIG. 2, after organizing all embeddings 228 into clusters 230, workflow 200 proceeds with a score generation component 218 determining an average proximity score 234 of the clusters 230 based on a respective centroid of each of the clusters 230. In certain embodiments, the average proximity score 234 may be based on inter-cluster proximity. For example, to determine the average proximity score 234, a distance, such as a Euclidean distance, may be calculated between each unique pair of centroids of each of the clusters 230 (e.g., the similarity of two clusters 230 may be defined as the similarity of their centroids). In certain embodiments, the average proximity score 234 may be based on intra-cluster proximity. For example, to determine the average proximity score 234, a distance, such as a Euclidean distance, may be calculated between each cluster's (230) centroid and an embedding 228 among the plurality of embeddings belonging (e.g., assigned) to the respective cluster 230. In certain embodiments, the average proximity score 234 may be based on both inter-cluster proximity and intra-cluster proximity. In certain aspects, the inter-cluster proximity and the intra-cluster proximity are equally weighted to determine the average proximity score 234.

For example, as shown at results 310 in FIG. 3, an average proximity score may be determined for the two clusters created for the 27 embeddings. In this example, the average proximity score is calculated based on inter-cluster similarity and intra-cluster similarity. For inter-cluster similarity, a first distance, such as a Euclidean distance may be calculated between a first centroid of the first cluster and a second centroid of the second cluster. For intra-cluster similarity, multiple second distances, such as multiple Euclidean distances, may be calculated between each embedding assigned to the first cluster and the first centroid of the first cluster (e.g., if the first cluster includes 13 of the 27 embeddings, then 13 second distances may be calculated). Further, multiple third distances, such as multiple Euclidean distances, may be calculated between each embedding assigned to the second cluster and the second centroid of the second cluster. The average proximity score may be calculated based on the first distance (e.g., an inter-cluster distance), the multiple second distances (e.g., multiple intra-cluster distances associated with the first cluster), and the multiple third distances (e.g., multiple intra-cluster distances associated with the second cluster).

Returning to FIG. 2, workflow 200 then proceeds with a hallucination determination component 220 determining whether the answers 224 generated by second language model 202 (e.g., the language model being tested), comprise a hallucination or not. For example, the hallucination determination component may make the determination based on (1) the number of clusters 232 created and/or (2) the average proximity score 234 determined for clusters 230. In certain embodiments, the hallucination determination component 220 may determine if answers 224 include a hallucination by second language model 202 based on comparing the average proximity score 234 to a threshold. The threshold may be configured and/or determined and set by a domain expert. In certain embodiments, an algorithm may test various thresholds with k samples (e.g., where k is an integer greater than one) to determine which threshold produces the best accuracy. This threshold, which results in the best accuracy, may be used by the hallucination determination component 220. In certain embodiments, the threshold may be optimized.

For example, as shown at results 310 in FIG. 3, based on (1) only two clusters being generated (e.g., a # of clusters=2) and (2) the average proximity score not satisfying a threshold (e.g., average proximity score<threshold indicating that the answers 306 are not likely a hallucination), the answers 306 may be determined to include benign output. Put differently, answers 306 may not include any hallucination; thus, second language model 202 may not be hallucinating on seed question 302 (e.g., “Who lives in the White House?”).

As shown in FIG. 2, based on its determination, hallucination determination component 220 may produce output 236. In some cases, output 236 may indicate that answers 224 generated by second language model 202 comprises a hallucination, or in other words, second language model 202 is hallucinating on seed question 204. In some other cases, output 236 may indicate that answers 224 generated by second language model 202 do not comprise a hallucination, or in other words, second language model 202 is not hallucinating on seed question 204.

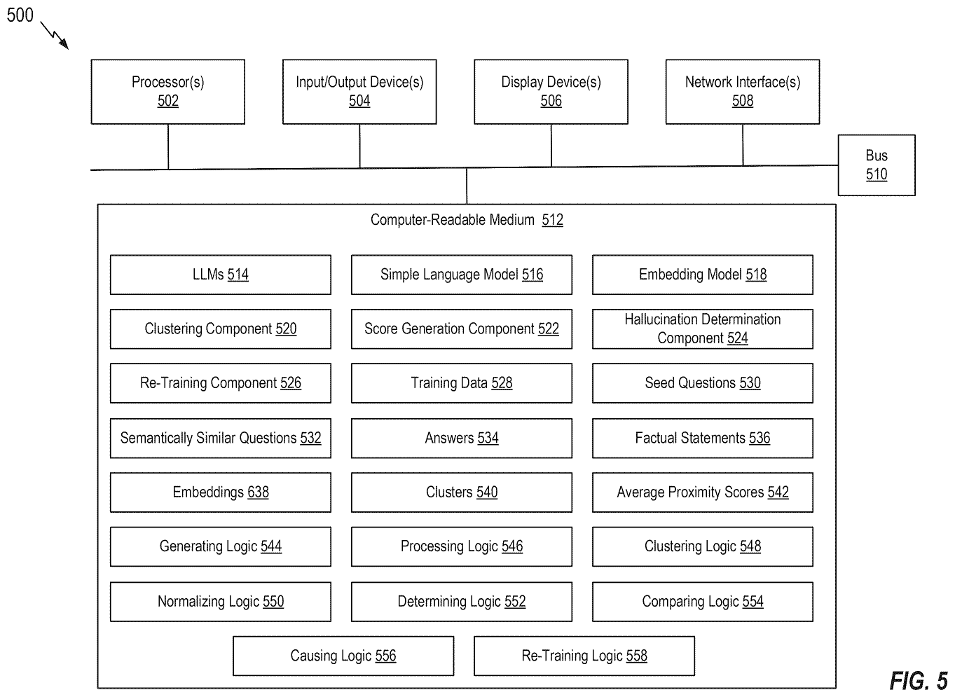

In certain embodiments, when second language model 202 is not hallucinating on seed question 204, at least one of the answers 224 may be displayed to a user (e.g., such a user that asked seed question 204). In certain embodiments, the answer(s) 224 may be displayed to the user via display devices 506 of processing system 500, depicted and described below with respect to FIG. 5. In certain embodiments, the answer(s) 224 displayed to the user may be selected at random. In certain embodiments, the answer(s) 224 displayed to the user may include repeating answers generated by second language model 202 when prompted with semantically similar questions 222 (e.g., majority vote). In certain embodiments, another language model (not shown in FIG. 2) may be prompted to process one or more of answers 224 and generate a presentation answer from them. The presentation answer may be answer displayed to the user.

As an illustrative example, four answers 224 may include (1) “As of my last update, the current CEO of Intuit is Sasan Goodarzi.”, (2) “Sasan Goodarzi has been serving as the CEO of Intuit since January 2019.”, (3) “Under Sasan Goodarzi's leadership, Intuit has focused on expanding its financial software solutions.”, (4) “Goodarzi joined Intuit in 2004 and has held various leadership roles before becoming CEO. For the most current information, please verify with the latest updates or Intuit's official website.” Summarizing these answers 224 may generate one presentation answer of “The current CEO of Intuit is Sasan Goodarzi, who has held the position since January 2019 after joining the company in 2004. Under his leadership, Intuit has focused on expanding its financial software solutions. For the latest updates, checking Intuit's official website is recommended.” It is noted that this is just one example presentation answer, and other presentation answers may be generated.

In certain embodiments, when second language model 202 is hallucinating in response to seed question 204, then one or more actions may be taken. For example, in certain embodiments, none of the answers 224 may be displayed to a user (e.g., such as a user that asked seed question 204). In certain embodiments, at least one of the answers 224 may be displayed to the user with a disclaimer or warning. The disclaimer or warning may indicate that the displayed answer(s) 224 may include a hallucination. In certain embodiments, the second language model 202 may be fine-tuned for the domain and/or subject matter associated with seed question 204. For example, second language model 202 may be re-trained with additional training data associated with seed question 204. Re-training second language model 202 as such may help to prevent second language model 202 from hallucinating on a similar and/or same type of question as seed question 204 in the future.

### Example Method for Hallucination Detection for Language Models

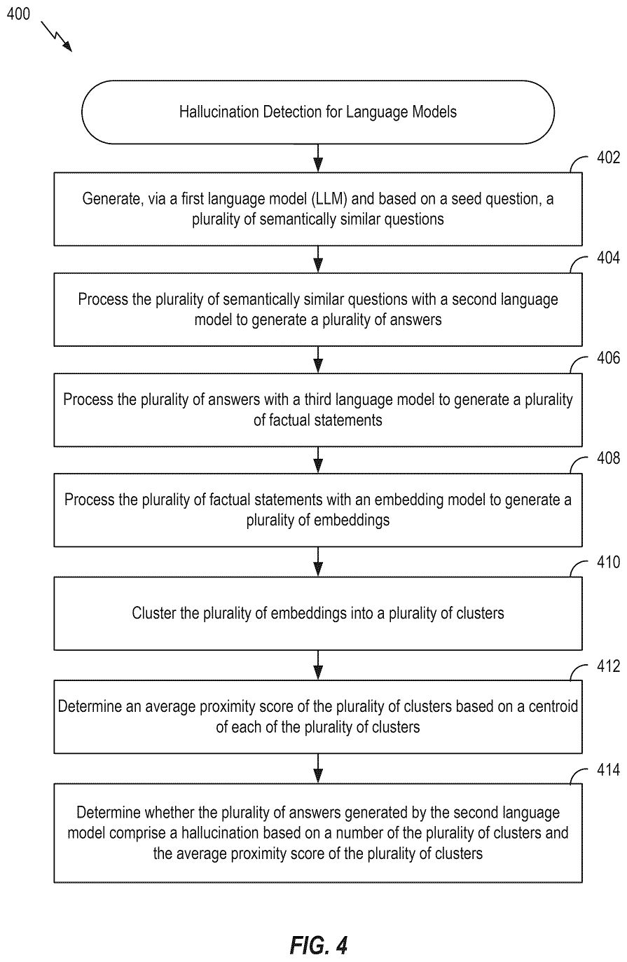

FIG. 4 depicts an example method 400 for hallucination detection for language models, such as LLMs. In one aspect, method 400 can be implemented by the system 100 of FIG. 1 and/or processing system 500 of FIG. 5.

Method 400 starts at block 402 with generating, via a first language model and based on a seed question, a plurality of semantically similar questions.

Method 400 continues to block 404 with processing the plurality of semantically similar questions with a second language model to generate a plurality of answers.

Method 400 continues to block 406 with processing the plurality of answers with a third language model to generate a plurality of factual statements.

Method 400 continues to block 408 with processing the plurality of factual statements with an embedding model to generate a plurality of embeddings.

Method 400 continues to block 410 with clustering the plurality of embeddings into a plurality of clusters.

Method 400 continues to block 412 with determining an average proximity score of the plurality of clusters based on a centroid of each of the plurality of clusters.

Method 400 continues to block 414 with determining whether the plurality of answers generated by the second language model comprise a hallucination based on a number of the plurality of clusters and the average proximity score of the plurality of clusters.

In certain embodiments, method 400 further includes determining the average proximity score of the plurality of clusters based on a Euclidean distance between each unique pair of centroids of each of the plurality of clusters.

In certain embodiments, method 400 further includes determining the average proximity score of the plurality of clusters based on a Euclidean distance between each unique pair comprising a centroid of a respective cluster of the plurality of clusters and an embedding among the plurality of embeddings belonging to the respective cluster.

In certain embodiments, determining whether the plurality of answers generated by the second language model comprise the hallucination based on the number of the plurality of clusters and the average proximity score of the plurality of clusters, at block 414, includes comparing the average proximity score of the plurality of clusters to a threshold.

In certain embodiments, method 400 further includes causing at least one of the plurality of answers to be displayed to a user.

In certain embodiments, method 400 further includes determining that the plurality of answers generated by the second language model comprise the hallucination; and re-training the second language model with additional training data associated with the seed question.

In certain embodiments, method 400 further includes determining that the plurality of answers generated by the second language model comprises the hallucination; and causing at least one of the plurality of answers and a disclaimer to be displayed to a user, wherein the disclaimer indicates that the at least one of the plurality of answers may include the hallucination.

In certain embodiments, method 400 further includes normalizing the plurality of embeddings prior to clustering the embeddings.

In certain embodiments, at least two of the plurality of factual statements are associated with one of the plurality of answers.

In certain embodiments, clustering the plurality of embeddings into the plurality of clusters, at block 410, is performed by: a hierarchical density-based clustering algorithm; or an agglomerative clustering algorithm.

In certain embodiments, the first language model comprise a first large langue model (LLM); the second language model comprises a second LLM; and the third language model comprises the first LLM, a third LLM or a simple language model.

In certain embodiments, the embedding model comprises a bidirectional encoder representations from transformers.

Method 400 provides the beneficial technical effects and acts a technical solution to the technical problem of hallucination detection. For example, method 400 leverages the fact that hallucinations have a wide range of variance in answers and based on this fact, (1) generate embeddings for various answers produced by a language model, (2) measure the distance (e.g., semantic distance) between the embeddings generated for the answers to evaluate their similarity and form clusters, and (3) determine whether the language model is hallucinating based on evaluating the created clusters (e.g., considering inter-cluster proximity and intra-cluster proximity). Using such techniques for hallucination detection may provide technical advantages of reduced resource consumption, scalability, and improved efficiency over conventional techniques.

Note that FIG. 4 is just one example of a method, and other methods including fewer, additional, or alternative operations are possible consistent with this disclosure.

### Example Processing System for Hallucination Detection

FIG. 5 depicts an example processing system 500 configured to perform various aspects described herein, including, for example, method 400 as described above with respect to FIG. 4.

Processing system 500 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 500 includes one or more processors 502, one or more input/output devices 504, one or more display devices 506, one or more network interfaces 508 through which processing system 500 is connected to one or more networks (e.g., a local network, an intranet, the Internet, or any other group of processing systems communicatively connected to each other), and computer-readable medium 512. In the depicted example, the aforementioned components are coupled by a bus 510, which may generally be configured for data exchange amongst the components. Bus 510 may be representative of multiple buses, while only one is depicted for simplicity.

Processor(s) 502 are generally configured to retrieve and execute instructions stored in one or more memories, including local memories like computer-readable medium 512, as well as remote memories and data stores. Similarly, processor(s) 502 are configured to store application data residing in local memories like the computer-readable medium 512, as well as remote memories and data stores. More generally, bus 510 is configured to transmit programming instructions and application data among the processor(s) 602, display device(s) 506, network interface(s) 508, and/or computer-readable medium 512. In certain embodiments, processor(s) 502 are representative of a one or more central processing units (CPUs), graphics processing unit (GPUs), tensor processing unit (TPUs), accelerators, and other processing devices.

Input/output device(s) 504 may include any device, mechanism, system, interactive display, and/or various other hardware and software components for communicating information between processing system 500 and a user of processing system 500. For example, input/output device(s) 504 may include input hardware, such as a keyboard, touch screen, button, microphone, speaker, and/or other device for receiving inputs from the user and sending outputs to the user.

Display device(s) 506 may generally include any sort of device configured to display data, information, graphics, user interface elements, and the like to a user. For example, display device(s) 506 may include internal and external displays such as an internal display of a tablet computer or an external display for a server computer or a projector. Display device(s) 506 may further include displays for devices, such as augmented, virtual, and/or extended reality devices. In various embodiments, display device(s) 506 may be configured to display a graphical user interface.

Network interface(s) 508 provide processing system 500 with access to external networks and thereby to external processing systems. Network interface(s) 508 can generally be any hardware and/or software capable of transmitting and/or receiving data via a wired or wireless network connection. Accordingly, network interface(s) 508 can include a communication transceiver for sending and/or receiving any wired and/or wireless communication.

Computer-readable medium 512 may be a volatile memory, such as a random access memory (RAM), or a nonvolatile memory, such as nonvolatile random access memory (NVRAM), or the like. In this example, computer-readable medium 512 includes LLMs 514, a simple language model 516, an embedding model 518, a clustering component 520, a score generation component 522, a hallucination determination component 524, a re-training component 526, training data 528, seed questions 530, semantically similar questions 532, answers 534, factual statements 536, embeddings 538, clusters 540, average proximity score 542, generating logic 544, processing logic 546, clustering logic 548, normalizing logic 550, determining logic 552, comparing logic 554, causing logic 556, and re-training logic 558.

In certain embodiments, generating logic 544 includes logic for generating, via a first language model and based on a seed question, a plurality of semantically similar questions.

In certain embodiments, processing logic 546 includes logic for processing the plurality of semantically similar questions with a second language model to generate a plurality of answers. In certain embodiments, processing logic 546 includes logic for processing the plurality of answers with a third language model to generate a plurality of factual statements. In certain embodiments, processing logic 546 includes logic for processing the plurality of factual statements with an embedding model to generate a plurality of embeddings.

In certain embodiments, clustering logic 548 includes logic for clustering the plurality of embeddings into a plurality of clusters.

In certain embodiments, normalizing logic 550 includes logic for normalizing the plurality of embeddings prior to clustering the embeddings.

In certain embodiments, determining logic 552 includes logic for determining an average proximity score of the plurality of clusters based on a centroid of each of the plurality of clusters. In certain embodiments, determining logic 552 includes logic for determining whether the plurality of answers generated by the second language model comprise a hallucination based on a number of the plurality of clusters and the average proximity score of the plurality of clusters. In certain embodiments, determining logic 552 includes logic for determining the average proximity score of the plurality of clusters based on a Euclidean distance between each unique pair of centroids of each of the plurality of clusters. In certain embodiments, determining logic 552 includes logic for determining the average proximity score of the plurality of clusters based on a Euclidean distance between each unique pair comprising a centroid of a respective cluster of the plurality of clusters and an embedding among the plurality of embeddings belonging to the respective cluster. In certain embodiments, determining logic 552 includes logic for determining that the plurality of answers generated by the second language model comprises the hallucination. In certain embodiments, determining logic 552 includes logic for determining that the plurality of answers generated by the second language model comprises the hallucination.

In certain embodiments, comparing logic 554 includes logic for comparing the average proximity score of the plurality of clusters to a threshold.

In certain embodiments, causing logic 556 includes logic for causing at least one of the plurality of answers to be displayed to a user. In certain embodiments, causing logic 556 includes logic for causing at least one of the plurality of answers and a disclaimer to be displayed to a user, wherein the disclaimer indicates that the at least one of the plurality of answers may include the hallucination.

In certain embodiments, re-training logic 558 includes logic for re-training the second language model with additional training data associated with the seed question.

Note that FIG. 5 is just one example of a processing system consistent with aspects described herein, and other processing systems having additional, alternative, or fewer components are possible consistent with this disclosure.

### Example Clauses

Implementation examples are described in the following numbered clauses:

Clause 1: A method of hallucination detection for language models, comprising: generating, via a first language model and based on a seed question, a plurality of semantically similar questions; processing the plurality of semantically similar questions with a second language model to generate a plurality of answers; processing the plurality of answers with a third language model to generate a plurality of factual statements; processing the plurality of factual statements with an embedding model to generate a plurality of embeddings; clustering the plurality of embeddings into a plurality of clusters; determining an average proximity score of the plurality of clusters based on a centroid of each of the plurality of clusters; and determining whether the plurality of answers generated by the second language model comprise a hallucination based on a number of the plurality of clusters and the average proximity score of the plurality of clusters.

Clause 2: The method of Clause 1, further comprising determining the average proximity score of the plurality of clusters based on a Euclidean distance between each unique pair of centroids of each of the plurality of clusters.

Clause 3: The method of any one of Clauses 1-2, further comprising determining the average proximity score of the plurality of clusters based on a Euclidean distance between each unique pair comprising a centroid of a respective cluster of the plurality of clusters and an embedding among the plurality of embeddings belonging to the respective cluster.

Clause 4: The method of any one of Clauses 1-3, wherein determining whether the plurality of answers generated by the second language model comprise the hallucination based on the number of the plurality of clusters and the average proximity score of the plurality of clusters comprises comparing the average proximity score of the plurality of clusters to a threshold.

Clause 5: The method of any one of Clauses 1-4, further comprising causing at least one of the plurality of answers to be displayed to a user.

Clause 6: The method of any one of Clauses 1-5, further comprising: determining that the plurality of answers generated by the second language model comprises the hallucination; and re-training the second language model with additional training data associated with the seed question.

Clause 7: The method of any one of Clauses 1-6, further comprising: determining that the plurality of answers generated by the second language model comprise the hallucination; and causing at least one of the plurality of answers and a disclaimer to be displayed to a user, wherein the disclaimer indicates that the at least one of the plurality of answers may include the hallucination.

Clause 8: The method of any one of Clauses 1-7, further comprising normalizing the plurality of embeddings prior to clustering the embeddings.

Clause 9: The method of any one of Clauses 1-8, wherein at least two of the plurality of factual statements are associated with one of the plurality of answers.

Clause 10: The method of any one of Clauses 1-9, wherein clustering the plurality of embeddings into the plurality of clusters is performed by: a hierarchical density-based clustering algorithm; or an agglomerative clustering algorithm.

Clause 11: The method of any one of Clauses 1-10, wherein: the first language model comprise a first large langue model (LLM); the second language model comprises a second LLM; and the third language model comprises a simple language model.

Clause 12: The method of any one of Clauses 1-11, wherein the embedding model comprises a bidirectional encoder representations from transformers.

Clause 13: A processing system, comprising: a memory comprising computer-executable instructions; and a processor configured to execute the computer-executable instructions and cause the processing system to perform a method in accordance with any one of Clauses 1-12.

Clause 14: A processing system, comprising means for performing a method in accordance with any one of Clauses 1-12.

Clause 15: A non-transitory computer-readable medium storing program code for causing a processing system to perform the steps of any one of Clauses 1-12.

Clause 16: A computer program product embodied on a computer-readable storage medium comprising code for performing a method in accordance with any one of Clauses 1-12.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of hallucination detection for language models, comprising:
generating, via a first language model and based on a seed question, a plurality of semantically similar questions;
processing the plurality of semantically similar questions with a second language model to generate a plurality of answers;
processing the plurality of answers with a third language model to generate a plurality of factual statements;
processing the plurality of factual statements with an embedding model to generate a plurality of embeddings;
clustering the plurality of embeddings into a plurality of clusters;
determining an average proximity score of the plurality of clusters based on a centroid of each of the plurality of clusters; and
determining whether the plurality of answers generated by the second language model comprise a hallucination based on a number of the plurality of clusters and the average proximity score of the plurality of clusters.

2. The method of claim 1, further comprising determining the average proximity score of the plurality of clusters based on a Euclidean distance between each unique pair of centroids of each of the plurality of clusters.

3. The method of claim 1, further comprising determining the average proximity score of the plurality of clusters based on a Euclidean distance between each unique pair comprising a centroid of a respective cluster of the plurality of clusters and an embedding among the plurality of embeddings belonging to the respective cluster.

4. The method of claim 1, wherein determining whether the plurality of answers generated by the second language model comprise the hallucination based on the number of the plurality of clusters and the average proximity score of the plurality of clusters comprises comparing the average proximity score of the plurality of clusters to a threshold.

5. The method of claim 1, further comprising causing at least one of the plurality of answers to be displayed to a user.

6. The method of claim 1, further comprising:
determining that the plurality of answers generated by the second language model comprises the hallucination; and
re-training the second language model with additional training data associated with the seed question.

7. The method of claim 1, further comprising:
determining that the plurality of answers generated by the second language model comprise the hallucination; and
causing at least one of the plurality of answers and a disclaimer to be displayed to a user, wherein the disclaimer indicates that the at least one of the plurality of answers may include the hallucination.

8. The method of claim 1, further comprising normalizing the plurality of embeddings prior to clustering the embeddings.

9. The method of claim 1, wherein at least two of the plurality of factual statements are associated with one of the plurality of answers.

10. The method of claim 1, wherein clustering the plurality of embeddings into the plurality of clusters is performed by:
a hierarchical density-based clustering algorithm; or
an agglomerative clustering algorithm.

11. The method of claim 1, wherein:
the first language model comprise a first large langue model (LLM);
the second language model comprises a second LLM; and
the third language model comprises a simple language model.

12. The method of claim 1, wherein the embedding model comprises a bidirectional encoder representations from transformers.

13. A processing system, comprising:
a memory comprising computer-executable instructions; and
a processor configured to execute the computer-executable instructions and cause the processing system to:
generate, via a first language model and based on a seed question, a plurality of semantically similar questions;
process the plurality of semantically similar questions with a second language model to generate a plurality of answers;
process the plurality of answers with a third language model to generate a plurality of factual statements;
process the plurality of factual statements with an embedding model to generate a plurality of embeddings;
cluster the plurality of embeddings into a plurality of clusters;
determine an average proximity score of the plurality of clusters based on a centroid of each of the plurality of clusters; and
determine whether the plurality of answers generated by the second language model comprises a hallucination based on a number of the plurality of clusters and the average proximity score of the plurality of clusters.

14. The processing system of claim 13, wherein the processor is configured to execute the computer-executable instructions and cause the processing system to determine the average proximity score of the plurality of clusters based on a Euclidean distance between each unique pair of centroids of each of the plurality of clusters.

15. The processing system of claim 13, wherein the processor is configured to execute the computer-executable instructions and cause the processing system to determine the average proximity score of the plurality of clusters based on a Euclidean distance between each unique pair comprising a centroid of a respective cluster of the plurality of clusters and an embedding among the plurality of embeddings belonging to the respective cluster.

16. The processing system of claim 13, wherein to determine whether the plurality of answers generated by the second language model comprise the hallucination based on the number of the plurality of clusters and the average proximity score of the plurality of clusters, the processor is configured to execute the computer-executable instructions and cause the processing system to compare the average proximity score of the plurality of clusters to a threshold.

17. The processing system of claim 13, wherein the processor is configured to execute the computer-executable instructions and cause the processing system to cause at least one of the plurality of answers to be displayed to a user.

18. The processing system of claim 13, wherein the processor is configured to execute the computer-executable instructions and cause the processing system to:
determine that the plurality of answers generated by the second language model comprises the hallucination; and
re-train the second language model with additional training data associated with the seed question.

19. The processing system of claim 13, wherein the processor is configured to execute the computer-executable instructions and cause the processing system to:
determine that the plurality of answers generated by the second language model comprise the hallucination; and
cause at least one of the plurality of answers and a disclaimer to be displayed to a user, wherein the disclaimer indicates that the at least one of the plurality of answers may include the hallucination.

20. The processing system of claim 13, wherein the processor is configured to execute the computer-executable instructions and cause the processing system to normalize the plurality of embeddings prior to clustering the embeddings.
